(19) United States
(12) Patent Application Publication
(10) Pub. No.: US 2016/0247106 A1
(43) Pub. Date: Aug. 25, 2016

(54) MANAGING A FLEET OF AUTONOMOUS ELECTRIC VEHICLES FOR ON-DEMAND TRANSPORTATION AND ANCILLARY SERVICES TO ELECTRICAL GRID

(71) Applicant: Siemens Aktiengesellschaft, Munich (DE)

(72) Inventors: Livio Dalloro, Princeton, NJ (US); Sanjeev Srivastava, Princeton, NJ (US); Lucia Mirabella, Plainsboro, NJ (US)

(21) Appl. No.: 15/047,703

(22) Filed: Feb. 19, 2016

Related U.S. Application Data
(60) Provisional application No. 62/119,968, filed on Feb. 24, 2015.

(51) Int. Cl. G06Q 10/06; G01C 21/34; G01C 21/36; G05D 1/00; G05D 1/02

(52) U.S. Cl. CPC G06Q 10/06313; G05D 1/0088; G05D 1/0291; G01C 21/3685; G01C 21/3492

(57) ABSTRACT

A computer-implemented method for managing a fleet of electric vehicles includes a fleet management computing system selecting an optimal vehicle fleet size and a plurality of discharging parking lot locations based on (i) historical electrical energy consumption for a geographic area and (ii) historical traffic flow though the geographic area during one or more time periods of interest. The fleet management computing system collects transportation demand data from a plurality of users comprising requests for transportation to locations within the geographic area and uses (i) the optimal vehicle fleet size, (ii) the plurality of discharging parking lot locations, and (iii) the transportation demand data to select routing information for each of a plurality of electric vehicles. Then, the fleet management computing system routes each respective autonomous vehicle according to its respective routing information.

### CROSS-REFERENCE TO RELATED APPLICATIONS

This application claims the benefit of U.S. Provisional Application Ser. No. 62/119,968 filed Feb. 24, 2015, which is incorporated herein by reference in its entirety.

### TECHNICAL FIELD

The present disclosure relates generally to methods, systems, and apparatuses related to managing a fleet of autonomous electric vehicles to provide on-demand transportation services, as well as ancillary power services to an electrical grid.

### BACKGROUND

Traditionally, passenger vehicles have been relatively primitive machines, dependent on constant interaction with a human driver in order to operate. As a result, each vehicle operates independently and there is little, if any, cooperation among vehicles on the roadways. Moreover, many vehicles rely on non-renewable fuel sources to operate. Thus, their operation results in a net deficit of energy resources for a community.

A recent development in vehicle technology is the use of vehicles which use artificial intelligence to semi-automate or automate vehicle operations. This technology offers the potential of a future where most, if not all, vehicles are autonomous. Moreover, many proposed designs of autonomous vehicles utilize a hybrid electric, or entirely electric, design. Thus, the vehicles will also offer an important commodity in the form of battery storage which, although primarily a requirement to provide energy to the autonomous vehicle, can also be utilized as a power generation source.

On the individual level, autonomous vehicles will address many drawbacks of modern vehicle design. However, because human intervention is eliminated, there is also a greater potential for coordination between vehicles in order to not only optimize the use of such vehicles for transportation, but also to leverage the use of each vehicle's battery storage and other resources. Moreover, in principle, a similar result may be achieved with electric vehicles that are not autonomous, but with dedicated drivers that follow the instructions that the fully autonomous vehicles would follow. Accordingly, it is desired to provide methods and systems which facilitate coordination among electric vehicles to provide on-demand transportation and ancillary services to the electrical grid.

### SUMMARY

Embodiments of the present invention address and overcome one or more of the above shortcomings and drawbacks, by providing methods, systems, and apparatuses related to managing a fleet of autonomous electric vehicles to provide on-demand transportation services and ancillary services to an electrical grid. More specifically, the techniques described herein present a multi-scale approach to manage a mix of multi-modal traffic (regular vehicles, autonomous electric vehicles) through the city infrastructure and optimize time efficiency of transportation and energy sustainability. The rationale behind these techniques resides in the unique merger of control, management, and optimization strategies from two different domains of a large network—vehicular traffic and electrical grid.

According to some embodiments, a computer-implemented method for managing a fleet of electric vehicles includes a fleet management computing system selecting an optimal vehicle fleet size and an plurality of discharging parking lot locations based on (i) historical electrical energy consumption for a geographic area and (ii) historical traffic flow though the geographic area during one or more time periods of interest. The fleet management computing system collects transportation demand data from users comprising requests for transportation to locations within the geographic area and uses (i) the optimal vehicle fleet size, (ii) the discharging parking lot locations, and (iii) the transportation demand data to select routing information for each of electric vehicles. Then, the fleet management computing system routes each respective autonomous vehicle according to its respective routing information.

Various techniques may be used for collecting the transportation demand data from the users in the aforementioned method. For example, in some embodiments, a server computing device maintained within the fleet management computing system is configured to communicate with applications installed on devices operated by the users. This server computing device can receive transportation requests from the users via the applications which may then be aggregated over a predetermined time period to yield the transportation demand data. In one embodiment, the transportation demand data is continuously updated based on new transportation requests received from the users via the applications or from one or more additional users. The routing information for one or more of the electric vehicles may then be updated based on updated transportation demand data.

In some embodiments, the aforementioned method includes one or more update processes that may be classified in three levels: macro, medium, and micro. During the macro level update process, updated historical data for energy consumption and traffic flow for the geographic area are received and used to update the optimal vehicle fleet size and the discharging parking lot locations. This macro level update process may be repeated, for example, on a monthly basis by the fleet management computing system. During the medium level update process, a high energy consumption area in the geographic area is identified, for example, based on real-time (or near real-time) energy use data. Next, the number of additional electric vehicles required in the high energy consumption area to meet a target power reduction or other ancillary services in the high energy consumption area is determined and routing information for one or more of the electric vehicles is updated accordingly based on energy demand. This medium level update process may be repeated, for example, hourly. Finally, during the micro level update process, traffic flow information corresponding to one or more intersections or points of confluence within the geographic area is received (e.g., based on near real-time position information corresponding to the electric vehicles). This traffic flow information is then used to update routing information for one or more of the electric vehicles. The micro level update process may be repeated many times per hour (e.g., several times per minute).

According to other embodiments of the present invention, an article of manufacture for managing a fleet of electric vehicles comprises a non-transitory, tangible computer-readable medium holding computer-executable instructions for performing the aforementioned method, with or without the additional features discussed above.

According to other embodiments, a system for managing a fleet of electric vehicles comprises electric vehicles (each having a battery) and a fleet management computing system. The fleet management computing system is configured to select discharging parking lot locations based on (i) historical electrical energy consumption for a geographic area, and (ii) historical traffic flow though the geographic area during one or more time periods of interest, and receive user requests for transportation to locations within the geographic area. The fleet management computing system is further configured to generate a routing instruction for each respective electric vehicle that satisfies one of the user requests and facilitates discharging of the battery associated with the respective electric vehicle at one of the discharging parking lot locations, and provide each of the electric vehicles with its respective routing instruction. Additionally, the fleet management computing system may communicate with applications installed on devices operated by users to receive user requests for transportation within the geographic area.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provides an overview of a system for optimizing traffic flow and power generation capabilities associated with a fleet of autonomous vehicles, according to some embodiments;

FIG. 2 provides an overview of the control and optimization process that may be applied in some embodiments of the present invention; and

FIG. 3 illustrates an exemplary computing environment within which embodiments of the invention may be implemented.

### DETAILED DESCRIPTION

The following disclosure describes the present invention according to several embodiments directed at methods, systems, and apparatuses related to managing a fleet of autonomous electric vehicles to provide on-demand transportation services and ancillary services related to the electrical grid. More specifically, the techniques described herein include a methodology to perform a multi-scale and multi-objective optimization to manage a fleet of fully autonomous vehicles by planning their routes and their charging/discharging location and time patterns to meet the on-demand transportation needs of the population and provide ancillary services to the power grid. Thus, the disclosed techniques may be used to facilitate the management and enhanced utilization of autonomous vehicles to meet not just commutation needs but also to support electrical grid operations such as peak load reduction.

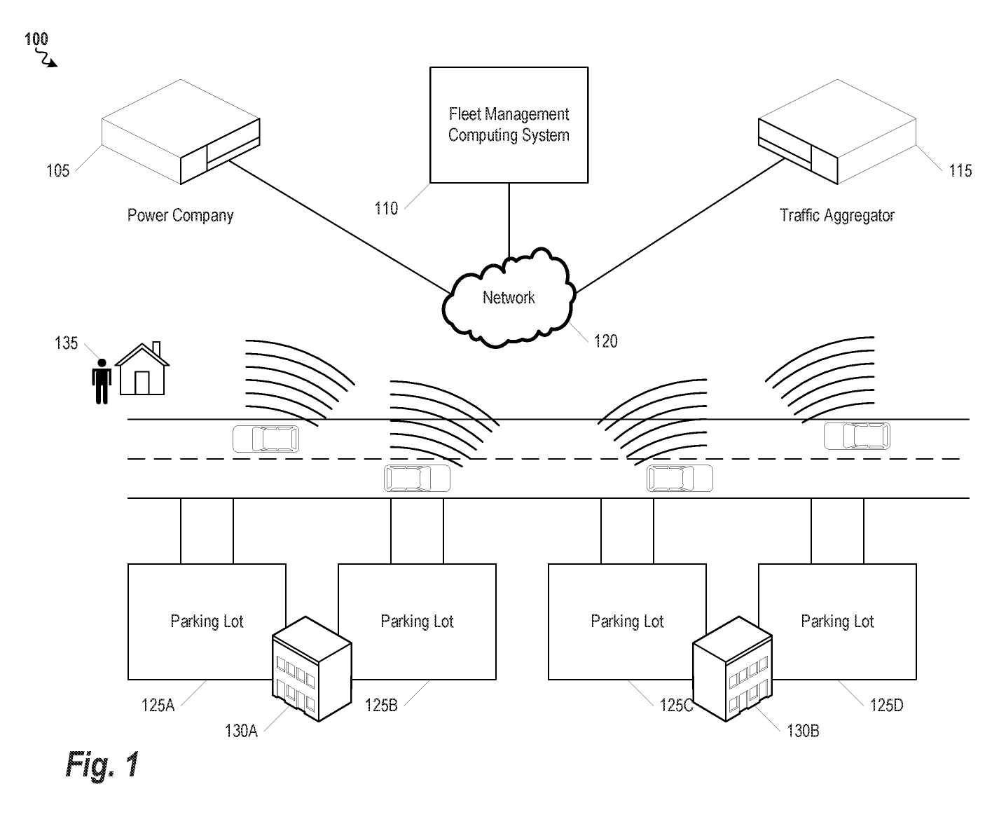

FIG. 1 provides an overview of a system 100 for optimizing traffic flow and power generation capabilities associated with a fleet of autonomous vehicles, according to some embodiments. Briefly, this system 100 comprises a Fleet Management Computing System 110 connected to a Power Company 105, a Traffic Aggregator 115, and a fleet of vehicles via a Computing Network 120. The system 100 is designed to move and distribute vehicles through a region of interest (e.g., metropolitan area) in the most efficient way, while optimizing the use of vehicles as power generating machines. In order to facilitate transportation to a destination, a user 135 contacts an on-demand commuting service which is capable of providing instructions to vehicles that are available to provide the desired transportation services. In some instances, these vehicles are autonomous and the instructions may be provided to an on-board computer capable of executing the instructions. However, instructions may additionally (or alternatively) be provided to human drivers of non-autonomous vehicles for execution in such vehicles.

Vehicles with various technologies can join the system 100, thereby forming car platoons under infrastructure support. In some embodiments, drivers may receive information about the platform on their dashboard to help join them. For autonomous cars, the control system of the car can be delegated to the platform. In conventional cars, drivers may be able to discover the platform through visual information displayed at intersections or by their connectivity devices. Although dedicated intersections or lanes can be envisaged for the platform, the architecture of the platform may apply to existing traffic intersections that handle non-platform participants. Such a system will take advantage of the vehicular and communication technologies embedded in each car to systematically optimize traffic, fuel consumption, and emissions.

It is assumed that at least some (and perhaps all) of the vehicles interacting with the system 100 have high capacity batteries capable of discharging power thorough a plug or another discharge mechanism. Such batteries may be available on hybrid vehicles or purely electric vehicles. The design of these types of vehicles can vary according to factors such as the manufacture of the vehicle or its intended country use. However, at a minimum, vehicles with high-capacity batteries typically provide some means for charging and discharging the battery. For example, some vehicles can plug directly into the electric grid. Such outlets can be strategically situated at locations at which the vehicle will remain parked for long periods of time (e.g., at a user's home, place of work, or a shopping center). While the individual battery may not be a large source of energy, a fleet of such battery storages can collectively be large enough to supply ancillary services to the electrical grid. This need is becoming more relevant because of the penetration of renewable energy technologies, many of which have reliability issues.

The system 100 in FIG. 1 includes four autonomous vehicles; however the general concepts discussed in this example may be scaled up or down to any number of vehicles. Each vehicle transports one or more passengers between two locations based on instructions supplied by the passengers. For example, an individual may request a vehicle transport the individual from his or her house to work. In some cases, the individual may own the vehicle, while in other instances the vehicle may be part of a transportation network where the vehicles pick-up and drop-off passengers on-demand. Each vehicle operates independently, but there is a collective behavior among the vehicles that influences their decisions. For example, if a large number of vehicles are using the primary route between two points, a vehicle may select an alternative route for traveling between those points with the goal of reducing travel time. In turn, this helps prevent congestion on the primary route.

The autonomous vehicles travel between an origin point (e.g., a user's home) and a destination point. In the example of FIG. 1, two structures 130A, 130B are shown. These structures 130A, 130B may be, for example, a workplace or a shopping facility. Each structure 130A, 130B in this example has two parking lots (i.e., lots 125A, 125B, 125C, and 125D, respectively) where autonomous vehicles can be parked while not in use. Thus, for example, if a user travels in an autonomous vehicle to structure 130A, the vehicle may be parked in parking lot 125A. Then, when the user wants to leave, the autonomous vehicle is readily retrievable. However, it should be noted that the autonomous vehicle does not necessarily need to park in parking lot 125A. Because it can operate autonomously, the vehicle may alternatively park in a remote lot (e.g., lot 125C or lot 125D). As discussed in further detail below, this capability is harnessed in the system to distribute the vehicles for joint traffic and energy optimization.

A Traffic Aggregator 115 collects information related to the operation of the autonomous vehicles including, for example, current location, speed, last stop, and current destination. This information is stored by the Traffic Aggregator 115 in one or more databases such that, over time, the typical activity of autonomous vehicles can be predicted. In addition to collecting data about the autonomous vehicles, in some embodiments, the Traffic Aggregator 115 may also collect data from non-autonomous vehicles. For example, a vehicle's position may be monitored based on a GPS-enabled tracking device installed within the vehicle or, alternatively, using data collected from one or more smartphones traveling in the vehicle. It should be noted that, although a single Traffic Aggregator 115 is shown in the example of FIG. 1, multiple traffic aggregators may be used in some embodiments. For example, different commercial providers may manage different traffic aggregators or traffic aggregators can be dedicated to serve a particular geographic region. In instances where multiple traffic aggregators are used, the aggregators may share data to provide a more thorough view of the overall vehicle environment.

A Power Company 105 collects information related to power consumption of residential and commercial structures (e.g., structures 130A, 130B) in a particular geographic area. As is well understood in the art, power consumption information may be collected through visual inspection of meters attached to individual structures or, alternatively, via wireless communication with such meters. Aside from general consumption information, the Power Company 105 may collect information related to battery usage at each structure. For example, structure 130A may have a battery installation that supplements an onsite solar or wind generation power source. The Power Company 105 may maintain real-time information related to the battery installation, including, for example, each battery's current capacity, estimated time until full charge, and predicted demand.

A Fleet Management Computing System 110 applies dynamic routing algorithms for vehicles so that they can meet the commutation demand of the passengers within the particular geographic region. At the same time, the Fleet Management Computing System 110 uses optimal dispatch controls based on stochastic algorithms to control the charge/discharge of the batteries such that they can provide the specific demand of a given ancillary service in which the parking building is participating.

The dynamic routing algorithms and optimal dispatch controls applied by the Fleet Management Computer 110 are linked in such a way to merge the commutation objectives with ancillary service demands. In order to achieve this higher level optimization, Swarm Intelligence (SI) is used so that the stochastic nature of operation of battery (charge/discharge) can be reconciled with ordered nature of ancillary service demand. SI is a form of collective intelligence spanning a distributed group of interacting autonomous agents. SI is an umbrella concept intended to cover collective behaviors observed in decentralized and self-organized systems. The concept was originally inspired by activities observed in nature such as group foraging among insects, river formation dynamics. In the examples presented herein, SI concepts are extended to manage the distribution of an autonomous fleet of vehicles. It is assumed that each vehicle has the ability to autonomously select the routes on which it travels and the locations at which it parks. The selections made by the vehicle may be overridden by the operator; however, absent any operator to the contrary, the vehicle is fully responsible for decisions made during its operations.

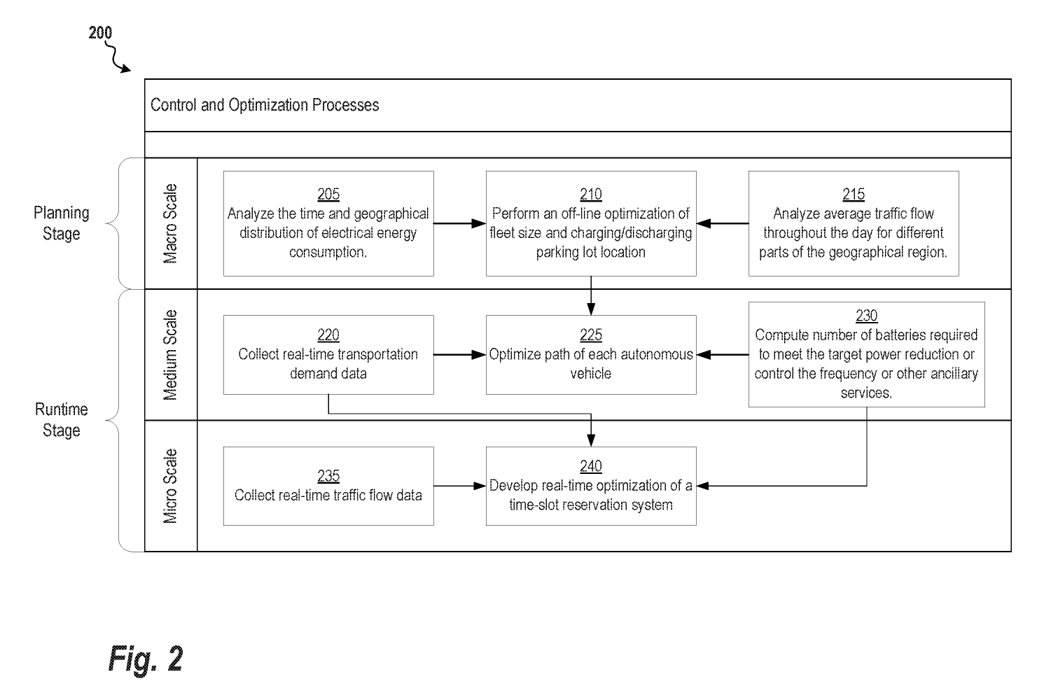

FIG. 2 provides an overview of the control and optimization process 200 that may be applied in some embodiments of the present invention. The process 200 is divided into two stages: a planning stage and a runtime stage. In planning stage, macro level methods for offline analysis and optimization are used to execute the steps set forth at 205-215. The time scale for the planning stage is on the order of months and spans the entire geographical region of interest. This region may be, for example, a metropolitan area, a state, or a country. The overall complexity of planning increases with the size of the region being analyzed; thus, the size may be limited based on factors such as computing resources or desired response time. During the runtime stage, control and optimization methods are developed in two different time scales. Steps 220-230 are performed at a medium level time scale, on the order of minutes or hours. Geographically, these steps focus on a finer level of detail than used at the planning stage (e.g., a town street map). Finally, steps 235-240 are performed at a micro level time scale, on the order of seconds or smaller time increments. The micro level analyzes data at the finest level of geographic detail (e.g., neighborhood intersections).

The planning stage steps 205-215 are performed for a particular region of interest, selectable by a user. At step 205, the time and geographical distribution of electrical energy consumption across the entire geographical region of interest is collected and analyzed. In some embodiments, monthly electrical data from power companies serving the region may be aggregated to provide an overview of consumption in the region. In other embodiments, during step 205, consumption data may be collected directly, for example, through interaction with meters attached to structures in the region of interest (e.g., via visual inspection or wireless retrieval). In this way, the granularity of the data may be increased beyond what is available in the aggregated monthly data from the power company.

At step 215 of the planning stage, average traffic flow throughout the day is collected and analyzed for different parts of the geographical region of interest. Depending on the configuration of the system performing the control and optimization process 200 illustrated in FIG. 2, step 215 may be performed before, after, or in parallel with step 205. As with the data analyzed at step 205, the traffic data analyzed at step 215 may be collected from an intermediary source such as local highway authorities (e.g., via road sensors) or commercial data provider. In some embodiments, traffic data may be collected directly from vehicles. For example, a vehicle's position may be monitored based on a GPS-enabled tracking device installed within the vehicle or, alternatively, using data collected from one or more smartphones traveling in the vehicle.

At step 210, the time, power consumption, and traffic information gathered at steps 205 and 215 are used to perform an off-line optimization of fleet size and charging/discharging parking lot location. More specifically, a cost function is formed which uses the time, power consumption, and traffic data as input and provides an output comprising the number of fully automated vehicles that should be injected in the traffic mix Nᵥ and the location and number of the charging/discharging parking lots P₁ . . . P_{N}_{ₚ}. The cost function may be minimized using any technique generally known in the art. For example, in some embodiments, particle swarm optimization techniques may be used, with each candidate solution of Nᵥ and P₁ . . . P_{N}_{ₚ} modeled as a particle. In other embodiments, more traditional optimization techniques may be employed such as, without limitation, gradient descent. The output information generated by the optimization will act as a constraint for the runtime optimization performed at step 225 (discussed below). Step 210 can be repeated in case of significant changes foreseen in Nᵥ and P₁ . . . P_{N}_{ₚ}.

Steps 220-230 illustrate the actions performed at the medium scale. First, at step 220, real-time transportation demand (e.g., in terms of origin, destination, and/or time frame) of individuals using the autonomous vehicle fleet is collected either directly through interaction with each vehicle in the fleet or through an intermediary resource that collects the relevant information. For example, in some embodiments, information is collected through communication with a computing device installed within the vehicle (e.g., an embedded computing system) or a computing device traveling with the individual in the vehicle (e.g., a smartphone). As an example of the latter scenario, a user may use a smartphone app to request transportation via the autonomous vehicle by supplying the origin and destination information. This information may be communicated directly or indirectly to autonomous vehicle in order to facilitate services. The origin and destination information may be relayed to a centralized system (e.g., Fleet Management Computing System 110) or it may be stored either on the smartphone or within the vehicle for later retrieval by such a centralized system. In a similar manner, real-time position information may be directly or indirectly connected to provide a measure of the time frame associated with traveling.

Next, at step 225, the demand information collected at step 220 and information output by step 210 are used to optimize the path of each autonomous vehicle such that (i) the demand of each user is met; and (ii) the autonomous vehicles reach the area (parking stations) where a need for power injection is expected, to provide ancillary services such as frequency regulation, loss compensation, load following, etc. This optimization may be performed throughout the day at discrete intervals. The provider of the on-demand commuting service receives N_{K} requests of transportation needs with start time Tₖ, start location L₀_{ₖ}, end location L₁_{ₖ}, for k=1 . . . N_{K}. The optimization algorithm takes Nᵥ, P₁ . . . P_{N}_{ₚ}, T_{K}, L₀_{_{K}}, L₁_{_{K}} as constraints, and it outputs the location of each vehicle Vᵢ, i=1 . . . Nᵥ in time and their status (idle or driving). As with the optimization performed at step 210, the optimization performed at step 225 may be implemented using techniques generally known in the art (e.g., particle swarm optimization, gradient descent, etc.).

Continuing with reference to FIG. 2, at step 230, a function is evaluated to determine the number of batteries (i.e., vehicles) required and their control (switching) sequence are computed to reduce power consumption in a geographic area of interest or control the frequency, or other ancillary services. In some embodiments, a desired power consumption reduction is specified and used in the calculation of the required number of batteries. Additionally, one or more high energy consumption areas may be identified (e.g., based on electrical energy consumption information collected at step 205) and used to in calculations at step 230. The function applied at step 230 takes as input information on the location and status of each vehicle Vᵢ generated at step 225 and the energy needs in the region of interest. Based on these inputs, the function destination parking lot and the discharging parameters to apply to each vehicle may be determined. As with step 220, step 230 may be performed throughout the day at discrete intervals.

Steps 235 and 240 show the actions performed at the micro scale. At step 235, real-time information is collected on the status of incoming traffic flow towards intersections and points of confluence using signals sent from vehicles and cameras located at intersections. At step 240, a real-time optimization of a time-slot reservation system is developed using variable length platoons adapted, using real-time transportation demand information collected at step 220 and the real-time traffic flow data collected at 230. The objective of this optimization is reducing commute time and car idling at congested points

The approach illustrated in FIG. 2 will include real-time optimization of traffic flow using a time-slot reservation system and variable length platoons of vehicles, dynamic routing algorithms, optimal dispatch controls of vehicle batteries based on stochastic algorithms, swarm based intelligence, so that the stochastic nature of operation of battery (charge/discharge) can be reconciled with ordered nature of ancillary service demand.

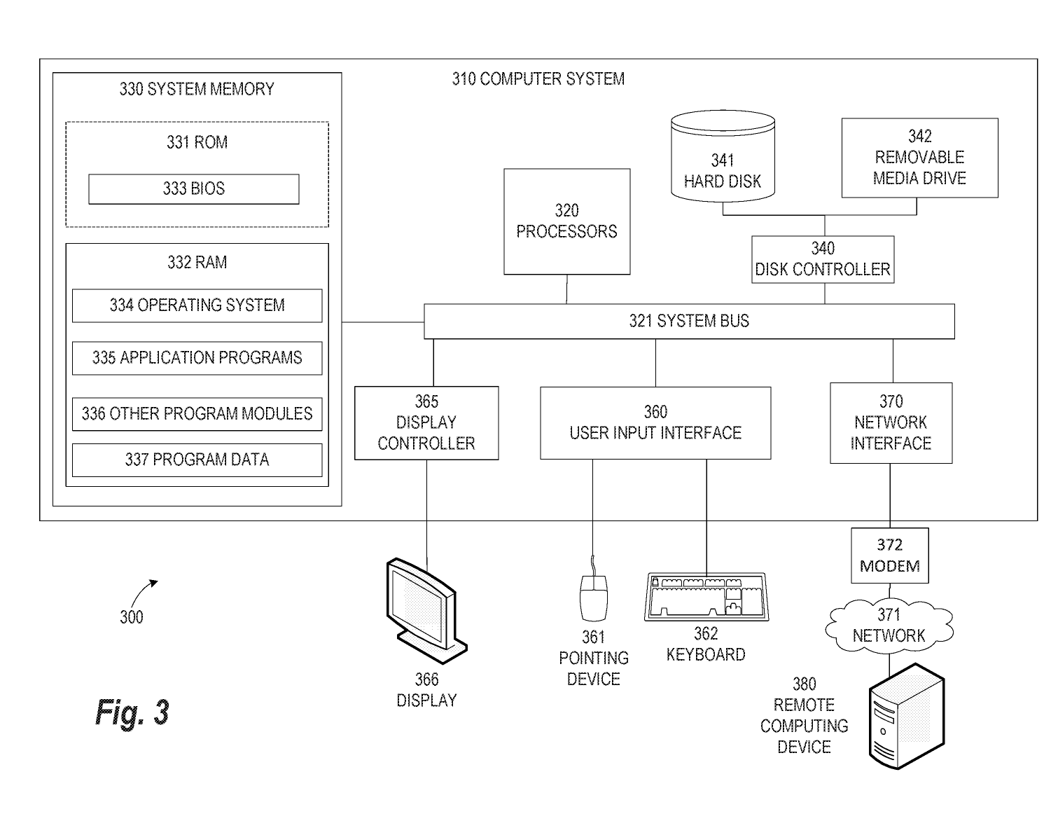

FIG. 3 illustrates an exemplary computing environment 300 within which embodiments of the invention may be implemented. In some embodiments, the computing environment 300 may be used to implement one or more of the components illustrated in the system 100 of FIG. 1. For example, this computing environment 300 may be configured to execute the control and optimization process 200 described above with respect to FIG. 2. Computers and computing environments, such as computer system 310 and computing environment 300, are known to those of skill in the art and thus are described briefly here.

As shown in FIG. 3, the computer system 310 may include a communication mechanism such as a bus 321 or other communication mechanism for communicating information within the computer system 310. The computer system 310 further includes one or more processors 320 coupled with the bus 321 for processing the information. The processors 320 may include one or more central processing units (CPUs), graphical processing units (GPUs), or any other processor known in the art.

The computer system 310 also includes a system memory 330 coupled to the bus 321 for storing information and instructions to be executed by processors 320. The system memory 330 may include computer readable storage media in the form of volatile and/or nonvolatile memory, such as read only memory (ROM) 331 and/or random access memory (RAM) 332. The system memory RAM 332 may include other dynamic storage device(s) (e.g., dynamic RAM, static RAM, and synchronous DRAM). The system memory ROM 331 may include other static storage device(s) (e.g., programmable ROM, erasable PROM, and electrically erasable PROM). In addition, the system memory 330 may be used for storing temporary variables or other intermediate information during the execution of instructions by the processors 320. A basic input/output system (BIOS) 333 containing the basic routines that helps to transfer information between elements within computer system 310, such as during start-up, may be stored in ROM 331. RAM 332 may contain data and/or program modules that are immediately accessible to and/or presently being operated on by the processors 320. System memory 330 may additionally include, for example, operating system 334, application programs 335, other program modules 336 and program data 337.

The computer system 310 also includes a disk controller 340 coupled to the bus 321 to control one or more storage devices for storing information and instructions, such as a hard disk 341 and a removable media drive 342 (e.g., floppy disk drive, compact disc drive, tape drive, and/or solid state drive). The storage devices may be added to the computer system 310 using an appropriate device interface (e.g., a small computer system interface (SCSI), integrated device electronics (IDE), Universal Serial Bus (USB), or FireWire).

The computer system 310 may also include a display controller 365 coupled to the bus 321 to control a display 366, such as a cathode ray tube (CRT) or liquid crystal display (LCD), for displaying information to a computer user. The computer system includes an input interface 360 and one or more input devices, such as a keyboard 362 and a pointing device 361, for interacting with a computer user and providing information to the processor(s) 320. The pointing device 361, for example, may be a mouse, a trackball, or a pointing stick for communicating direction information and command selections to the processor(s) 320 and for controlling cursor movement on the display 366. The display 366 may provide a touch screen interface which allows input to supplement or replace the communication of direction information and command selections by the pointing device 361.

The computer system 310 may perform a portion or all of the processing steps of embodiments of the invention in response to the processors 320 executing one or more sequences of one or more instructions contained in a memory, such as the system memory 330. Such instructions may be read into the system memory 330 from another computer readable medium, such as a hard disk 341 or a removable media drive 342. The hard disk 341 may contain one or more datastores and data files used by embodiments of the present invention. Datastore contents and data files may be encrypted to improve security. The processors 320 may also be employed in a multi-processing arrangement to execute the one or more sequences of instructions contained in system memory 330. In alternative embodiments, hard-wired circuitry may be used in place of or in combination with software instructions. Thus, embodiments are not limited to any specific combination of hardware circuitry and software.

As stated above, the computer system 310 may include at least one computer readable medium or memory for holding instructions programmed according to embodiments of the invention and for containing data structures, tables, records, or other data described herein. The term “computer readable medium” as used herein refers to any medium that participates in providing instructions to the processor(s) 320 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 341 or removable media drive 342. Non-limiting examples of volatile media include dynamic memory, such as system memory 330. Non-limiting examples of transmission media include coaxial cables, copper wire, and fiber optics, including the wires that make up the bus 321. Transmission media may also take the form of acoustic or light waves, such as those generated during radio wave and infrared data communications.

The computing environment 300 may further include the computer system 310 operating in a networked environment using logical connections to one or more remote computers, such as remote computer 380. Remote computer 380 may be a personal computer (laptop or desktop), a mobile device, a server, a router, a network PC, a peer device or other common network node, and typically includes many or all of the elements described above relative to computer system 310. When used in a networking environment, computer system 310 may include modem 372 for establishing communications over a network 371, such as the Internet. Modem 372 may be connected to bus 321 via user network interface 370, or via another appropriate mechanism.

Network 371 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 310 and other computers (e.g., remote computer 380). The network 371 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 371.

The embodiments of the present disclosure may be implemented with any combination of hardware and software. In addition, the embodiments of the present disclosure may be included in an article of manufacture (e.g., one or more computer program products) having, for example, computer-readable, non-transitory media. The media has embodied therein, for instance, computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor(s) to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images enabling user interaction with a processor or other device and associated data acquisition and processing functions. The GUI also includes an executable procedure or executable application. The executable procedure or executable application conditions the processor(s) to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor(s) or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

1. A computer-implemented method for managing a fleet of electric vehicles, the method comprising:
selecting, by a fleet management computing system, an optimal vehicle fleet size and an plurality of discharging parking lot locations based on (i) historical electrical energy consumption for a geographic area and (ii) historical traffic flow though the geographic area during one or more time periods of interest;
collecting, by the fleet management computing system, transportation demand data from a plurality of users comprising requests for transportation to locations within the geographic area;
using, by the fleet management computing system, (i) the optimal vehicle fleet size, (ii) the plurality of discharging parking lot locations, and (iii) the transportation demand data to select routing information for each of a plurality of electric vehicles; and
routing, by the fleet management computing system, each respective autonomous vehicle according to its respective routing information.

2. The method of claim 1, wherein collecting the transportation demand data from the plurality of users comprises:
maintaining a server computing device within the fleet management computing system configured to communicate with applications installed on devices operated by the plurality of users;
receiving, by the server computing device, a plurality of transportation requests from the plurality of users via the applications; and
aggregating the plurality of transportation requests over a predetermined time period to yield the transportation demand data.

3. The method of claim 2, wherein the transportation demand data is continuously updated based on new transportation requests received from the plurality of users via the applications or from one or more additional users.

4. The method of claim 3, further comprising:
updating routing information for one or more of the plurality of electric vehicles based on updated transportation demand data.

5. The method of claim 1, wherein the method includes a macro level update process comprising:
receiving updated historical electrical energy consumption for the geographic area;
receiving updated historical traffic flow though the geographic area; and
updating the optimal vehicle fleet size and the plurality of discharging parking lot locations based on (i) the updated historical electrical energy consumption in the geographic area and (ii) the updated historical traffic flow though the geographic area.

6. The method of claim 5, wherein the macro level update process is repeated on a monthly basis by the fleet management computing system.

7. The method of claim 1, wherein the method includes a medium level update process comprising:
identifying a high energy consumption area in the geographic area;
determining a number of additional electric vehicles required in the high energy consumption area to meet a target power reduction or other ancillary services in the high energy consumption area; and
updating routing information for one or more of the plurality of electric vehicles based on the number of additional electric vehicles required according to energy demand.

8. The method of claim 7, wherein the energy demand is identified based on near-real time energy use data.

9. The method of claim 8, wherein the medium level update process is repeated at least once per hour.

10. The method of claim 1, wherein the method includes a micro level update process comprising:
receiving traffic flow information corresponding to one or more intersections or points of confluence within the geographic area; and
updating routing information for one or more of the plurality of electric vehicles based on the transportation demand data and the traffic flow information.

11. The method of claim 10, further comprising:
receiving near real-time position information corresponding to the plurality of electric vehicles; and
determining the traffic flow information based on the position information.

12. The method of claim 11, wherein the micro level update process is repeated at least once per minute.

13. An article of manufacture for managing a fleet of electric vehicles, the article of manufacture comprising a non-transitory, tangible computer-readable medium holding computer-executable instructions for performing a method comprising:
selecting a plurality of discharging parking lot locations based on (i) historical electrical energy consumption for a geographic area, and (ii) historical traffic flow though the geographic area during one or more time periods of interest;
receiving a plurality of user requests for transportation to locations within the geographic area;
selecting a plurality of electric vehicles in the fleet of electric vehicles, each respective electric vehicle comprising a battery;
generating routing information for each respective electric vehicle that satisfies one of the plurality of user requests for transportation and facilitates discharging of the battery associated with the respective electric vehicle at one of the plurality of discharging parking lot locations; and
providing each of the plurality of electric vehicles an instruction dataset corresponding to its respective routing information.

14. The article of manufacture of claim 13, wherein receiving the plurality of user requests for transportation to locations within the geographic area comprises:
communicating with applications installed on devices operated by a plurality of users;
receiving the plurality of user requests for transportation from the plurality of users via the applications.

15. The article of manufacture of claim 13, wherein the method includes a macro level update process comprising:
receiving updated historical electrical energy consumption for the geographic area;
receiving updated historical traffic flow though the geographic area; and
updating the plurality of discharging parking lot locations based on (i) the updated historical electrical energy consumption in the geographic area and (ii) the updated historical traffic flow though the geographic area.

16. The article of manufacture of claim 13, wherein the method includes a medium level update process comprising:
identifying a high energy consumption area in the geographic area;
determining a number of additional electric vehicles required in the high energy consumption area to meet a target power reduction or other ancillary services in the high energy consumption area; and
updating routing information for one or more of the plurality of electric vehicles based on the number of additional electric vehicles required in specific areas according to energy demand.

17. The article of manufacture of claim 13, wherein the method includes a micro level update process comprising:
receiving traffic flow information corresponding to one or more intersections or points of confluence within the geographic area; and
updating routing information for one or more of the plurality of electric vehicles based on the plurality of user requests for transportation and the traffic flow information.

18. The article of manufacture of claim 13, wherein the method further comprises:
selecting an optimal vehicle fleet size based on (i) the historical electrical energy consumption for the geographic area, and (ii) the historical traffic flow though the geographic area during the one or more time periods of interest,
wherein selecting the plurality of electric vehicles in the fleet of electric vehicles is based on the optimal vehicle fleet size.

19. A system for managing a fleet of electric vehicles, the system comprising:
a plurality of electric vehicles, each electric vehicle comprising a battery; and
a fleet management computing system configured to:
select a plurality of discharging parking lot locations based on (i) historical electrical energy consumption for a geographic area, and (ii) historical traffic flow though the geographic area during one or more time periods of interest,
receive a plurality of user requests for transportation to locations within the geographic area, and
generate a routing instruction for each respective electric vehicle that satisfies one of the plurality of user requests and facilitates discharging of the battery associated with the respective electric vehicle at one of the plurality of discharging parking lot locations,
provide each of the plurality of electric vehicles with its respective routing instruction.

20. The system of claim 19, wherein the fleet management computing system is further configured to:
communicate with applications installed on devices operated by a plurality of users to receive the plurality of user requests for transportation within the geographic area.
